(19) United States
(12) Patent Application Publication
(10) Pub. No.: US 2002/0167671 A1
(43) Pub. Date: Nov. 14, 2002

(54) Linear translation apparatus for optical systems

(76) Inventors: Gregory S. Hill, Santa Rosa, CA (US); Mark E. Young, Santa Rosa, CA (US); Michael B. North-Morris, Santa Rosa, CA (US)

Correspondence Address: AGILENT TECHNOLOGIES, INC., Legal Department, 51U-PD, Intellectual Property Administration, P.O. Box 58043, Santa Clara, CA, 95052-8043, US

(21) Appl. No.: 09/854,047

(22) Filed: May 11, 2001

(51) Int. Cl. G01B 9/02

(52) U.S. Cl. 356/452; 359/872

(57) ABSTRACT

A linear translation apparatus for optical systems has a tube and a piston that slides along an inner wall of the tube that is disposed about a longitudinal axis. An optical element mounted on the piston intercepts optical signals entering the tube so that optical path lengths within the optical system are varied as the piston moves along the longitudinal axis. The piston has a magnetic moment enabling the piston to slide along the inner wall in response to the strength and direction of a magnetic field generated by a magnetic actuator. A driver coupled to the magnetic actuator establishes the strength and direction of the generated magnetic field to achieve a predesignated motion profile for the piston along the longitudinal axis.

### BACKGROUND AND SUMMARY OF THE INVENTION

In many types of optical systems, the position of optical elements is dynamically varied to adjust optical path lengths. For example, a retro-reflector within an interferometer is linearly translated to time-vary the optical path length of a measurement arm of the interferometer. Prior art linear translation mechanisms convert rotational motion of a rotary motor into a corresponding linear motion to achieve linear translation of optical elements. However, the rotary motor and mechanical coupling involved in this type of conversion add cost and complexity to the optical systems in which these types of linear translation mechanisms are included. There is a need to achieve linear translation of optical elements within an optical system without the cost and complexity associated with these prior art linear translation mechanisms. This need is met by a linear translation apparatus constructed according to the embodiments of the present invention.

### BRIEF DESCRIPTION OF THE DRAWINGS

FIG. 1 shows a prior art linear translation mechanism.

FIGS. 2A-2B, 3 show a linear translation apparatus constructed according to the embodiments of the present invention.

### DETAILED DESCRIPTION OF THE EMBODIMENTS

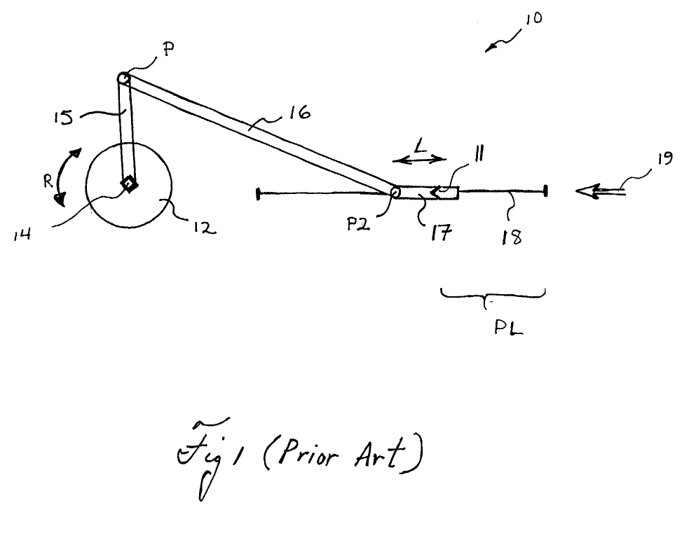

FIG. 1 shows a prior art linear translation mechanism 10, that converts rotational motion R into a corresponding linear motion L to achieve linear translation of an optical element 11 so that an optical path length traversed by an applied optical signal 19 within an optical 5 system can be adjusted. The prior art linear translation mechanism 10 includes a rotary motor 12 having a drive shaft 14 that rotates a crank arm 15. The crank arm 15 is coupled to a connecting rod 16 thru a pivot P1. The connecting rod 16 is coupled to a sled 17 through a pivot P2. The optical element 11 is mounted on the sled 17 and receives the optical signal 19. The sled 17 rides along a guide rail 18, varying the position of the optical element 11 in a linear fashion, as the rotary motor 12 spins the drive shaft 14. The rotary motor 12 and mechanical coupling used to convert the rotational motion of the rotary motor 12 to the corresponding linear motion along the guide rail 18 adds cost and complexity to optical systems in which these prior art linear translation mechanisms 10 are included.

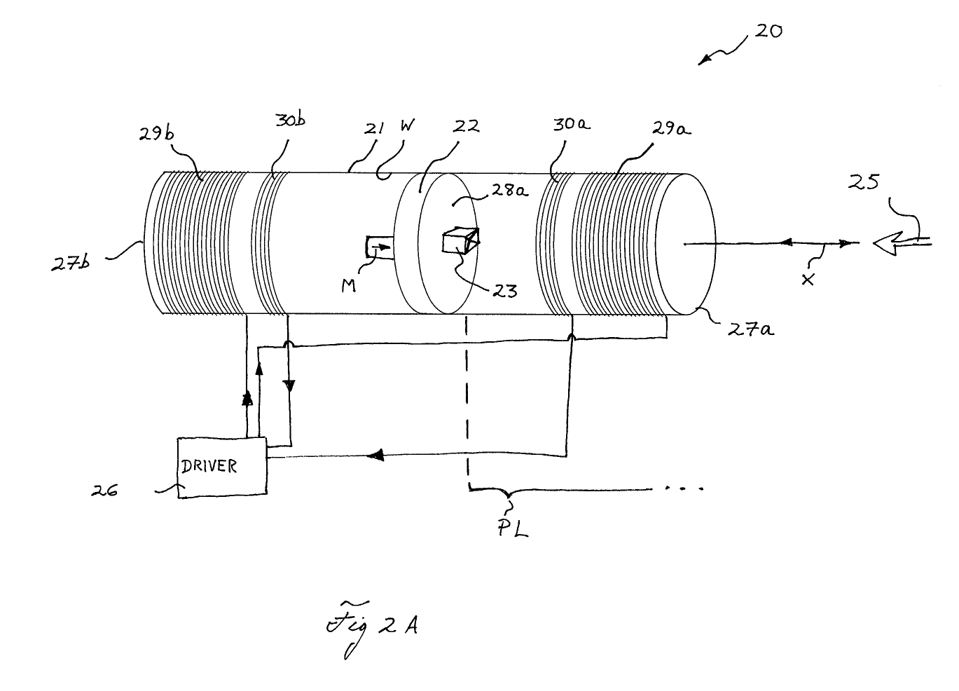

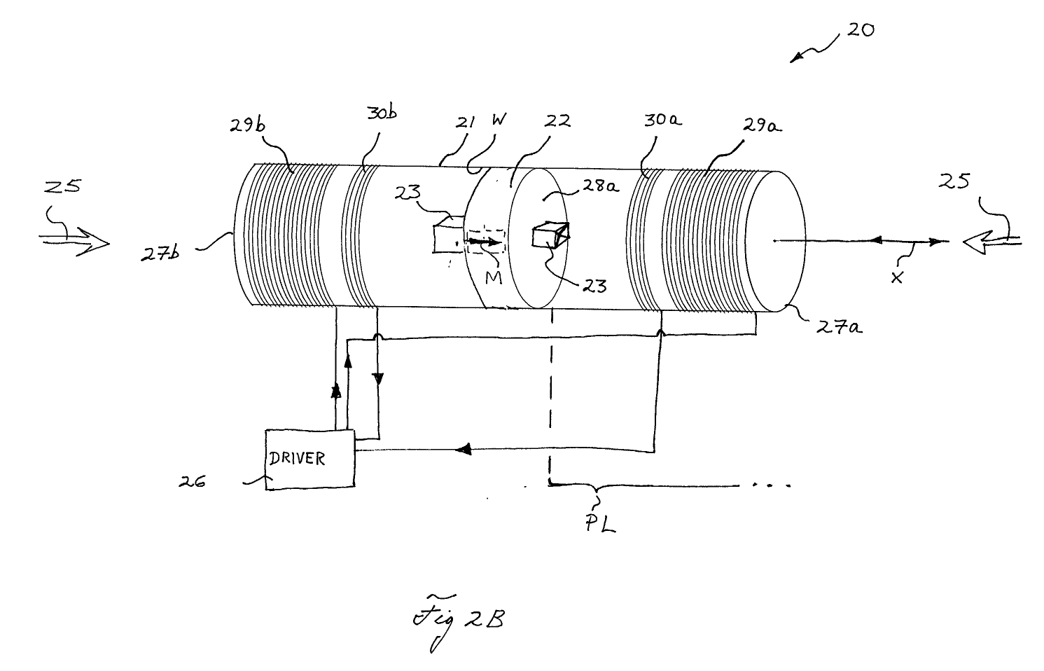

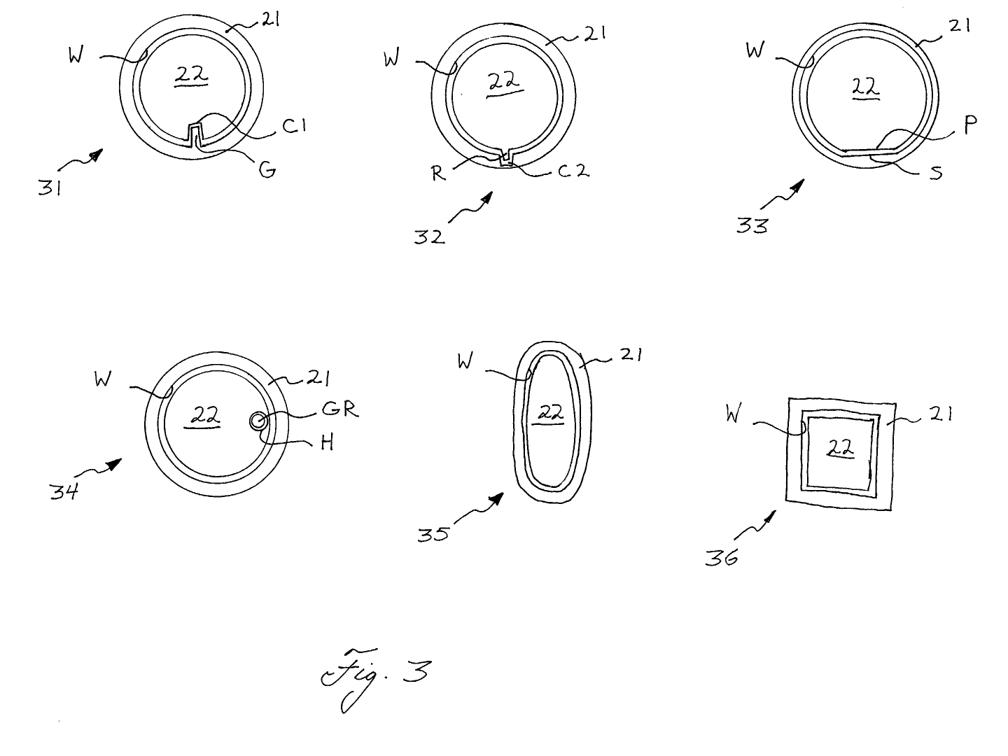

FIGS. 2A-2B and FIG. 3 show aspects of a linear translation apparatus 20 constructed according to the embodiments of the present invention. The linear translation apparatus 20 includes a tube 21 having an inner wall W disposed about a longitudinal axis X, and a piston 22 configured to slide within the inner wall W of the tube 21 along the longitudinal axis X. An optical element 23 is mounted on the piston 22, intercepting optical signals 25 entering the tube 21. The optical element 23 is linearly translated along the longitudinal axis X as the piston 22 slides along the inner wall W of the tube 21. Linear translation of the optical element 23 enables adjustment of an optical path length PL within an optical system in which the linear translation apparatus 20 is included.

The piston 22 has a magnetic moment M aligned with the longitudinal axis X, enabling the piston 22 to slide within the tube 21 in response to the strength and direction of a magnetic field generated by a magnetic actuator 29a, 29b that is positioned sufficiently close to the piston 22 to influence the position, velocity, acceleration or jerk of the piston 22, where jerk is the time derivative of the acceleration of the piston 22. A driver 26, coupled to the magnetic actuator 29a, 29b establishes a profile for the strength and direction of the magnetic field generated by the magnetic actuator.

The linear translation apparatus 20 is well-suited for inclusion in interferometers, optical oscilloscopes, optical spectrum analyzers, optical wave meters, optical communication networks and other types of optical systems where adjustment of the optical path length is made by linearly translating optical elements. The type of optical element 23 that is mounted on the piston 22 depends on the type of optical system in which the linear translation apparatus 20 is included. As examples, the optical element 23 is a retroreflector, corner cube, planar mirror, photodetector, beam splitter, dispersive element, a combination of these elements, or any other optical device or component or array of optical devices or components, suitable for mounting on the piston 22 and intercepting applied optical signals 25.

The tube 21 and piston 22 are made of glass, graphite, metal, plastic or any other materials that enable the piston 22 to freely slide along the inner wall W of the tube 21. In one example, the tube 21 is made of glass and the piston 22 is made of graphite, making the tube 21 and piston 22 inexpensive to manufacture.

The tube 21 is optically transmissive at one end 27a as shown in FIG. 2A, or at both ends 27a, 27b as shown in FIG. 2B, depending on the type of optical system in which the linear translation apparatus 20 is included. In optical systems where optical signals 25 enter the tube 21 at only one end 27a, the tube 21 is optically transmissive at at least the end 27a at which the optical signal 25 enters. Here, the optical element 23 is typically placed on the side 28a of the piston 22 facing the end 27a of the tube 21 receiving the optical signal 25 as shown in FIG. 2A. In optical systems where optical signals 25 enter the tube 21 at both ends 27a, 27b, the tube 21 is optically transmissive at each of the ends 27a, 27b and an optical element 23 is typically placed on each of the opposing sides of the piston 22 as shown in FIG. 2B. An end of the tube 21 is made optically transmissive by keeping the end of the tube 21 open, forming an aperture in the end of the tube 21, or positioning a focusing element, filter, or other optical component (not shown) at the end of the tube 21 that is capable of transmitting at least a portion of the applied optical signal 25 to the optical element 23, when the optical signal 25 is applied to the optically transmissive end.

When the linear translation apparatus 20 is included in optical systems where it is preferred that the optical element 23 does not rotate about the longitudinal axis X as piston 22 slides along the inner wall W of the tube 21, the piston 22 and the tube 21 are keyed to prevent rotation of the piston 22 about the longitudinal axis X. Generally, the piston 22 and tube 21 are keyed by forming the piston 22 and inner wall W of the tube 21 to have corresponding cross-sections, taken orthogonal to the longitudinal axis X, that are not radially symmetric. FIG. 3 shows examples of corresponding non-radially symmetric cross-sections of the piston 22 and tube 21, keying the piston 22 and tube 21 to prevent rotation of the piston 22 about the longitudinal axis X. In the cross-section 31, the inner wall W of the tube 21 includes a guide G parallel to the longitudinal axis X and the piston 22 includes a channel C1 configured to receive the guide G. In the cross-section 32, the piston 22 includes a ridge R and the inner wall W includes a channel C2 parallel to the longitudinal axis X configured to receive the ridge R. In the cross-section 33, the inner wall W of the tube 21 includes a flat segment S extending parallel to the longitudinal axis X and the piston 22 includes a flat portion P aligned with the flat segment of the inner wall W. In the cross-section 34, the piston 22 and tube 21 are keyed to prevent rotation of the piston 22 about the longitudinal axis X using a guide rod GR threaded through a hole H in the piston 22. In the cross-sections 35-36, the piston 22 and tube 21 are keyed by making the corresponding cross-sections, elliptical or square. Other non-radially symmetric cross-sections are also well suited for keying the piston 22 and tube 21.

The magnetic moment M of the piston 22 is established by a magnetic material oriented to have a net magnetic field component, or magnetic moment M, aligned with the longitudinal axis X when the piston 22 is within the tube 21. The magnet material is integrated into the piston 22, or the magnetic material is comprised in a permanent magnet PM that is attached to the piston 22. In the example shown in FIGS. 2A-2B, a rare earth permanent magnet PM is fastened to the piston 22, with the North-South axis of the permanent magnet PM aligned with the longitudinal axis X. Alternatively, the magnetic moment M is established by a ferromagnetic material that is magnetized by the presence of an applied magnetic field.

The magnetic actuator 29a, 29b is a formed by a pair of coils 29a, 29b wound around corresponding ends 27a, 27b of the tube 21. The coils 29a, 29b are driven to produce a magnetic field having a magnetic field component aligned with the longitudinal axis X and the magnetic moment M of the piston 22. Alternatively the magnetic actuator 29a, 29b is a single coil driven to produce a magnetic field having a magnetic field component aligned with the longitudinal axis X and the magnetic moment M of the piston 22, or the magnetic actuator 29a, 29b is a permanent magnet or series of permanent magnets manipulated to produce a magnetic field having a magnetic field component aligned with the longitudinal axis X and the magnetic moment M of the piston 22. Due to the magnetic moment M of the piston 22, the magnetic field generated by the magnetic actuator 29a, 29b is capable of exerting a force on the piston 22, enabling the position of the piston 22 to be varied within the tube 21 along the longitudinal axis X.

The driver 26 establishes the strength and direction of the generated magnetic field to achieve a predesignated motion profile for the piston 22, such as a position, velocity, acceleration or jerk profile. One or more magnetic pickups 30, shown as coils 30a, 30b in FIGS. 2A-2B, optionally included in the apparatus 20 sense the position of the piston 22 along the longitudinal axis X via the magnetic moment M. The magnetic pickups 30a, 30b are coupled to the driver 26 to influence the strength and direction of the magnetic field according to the position of the piston 22 to ensure that the motion of the piston 22 conforms to the predesignated motion profile.

While the embodiments of the present invention have been illustrated in detail, it should be apparent that modifications and adaptations to these preferred embodiments may occur to one skilled in the art without departing from the scope of the present invention as set forth in the following claims.

What is claimed is:

1. A linear translation apparatus for an optical system, comprising:
a tube having an inner wall disposed about a longitudinal axis, the tube optically transmissive at at least one of a first end and a second end;
a piston having a magnetic moment aligned with the longitudinal axis, configured to slide along the inner wall of the tube along the longitudinal axis;
at least one optical element mounted on the piston intercepting optical signals from the at least one optically transmissive end;
a magnetic actuator generating a magnetic field aligned with the longitudinal axis, positioned sufficiently close to the piston to vary the position of the piston along the longitudinal axis according to a strength and a direction of the generated magnetic field; and
a driver coupled to the magnetic actuator, establishing the strength and direction of the generated magnetic field to achieve a predesignated motion profile for the piston.

2. The linear translation apparatus of claim 1 wherein the tube and the piston are keyed to prevent rotation of the piston about the longitudinal axis.

3. The linear translation apparatus of claim 1 wherein the magnetic actuator includes a first coil positioned at the first end of the tube and a second coil positioned at the second end of the tube.

4. The linear translation apparatus of claim 2 wherein the magnetic actuator includes a first coil positioned at the first end of the tube and a second coil positioned at the second end of the tube.

5. The linear translation apparatus of claim 3 wherein the first coil and the second coil are wound about an outer wall of the tube.

6. The linear translation apparatus of claim 4 wherein the first coil and the second coil are wound about an outer wall of the tube.

7. The linear translation apparatus of claim 3 further including at least one magnetic pickup, positioned sufficiently close to the piston to sense the position of the piston along the longitudinal axis, the at least one magnetic pickup communicating with the driver so as to influence the strength and the direction of the generated magnetic field according to the sensed position of the piston.

8. The linear translation apparatus of claim 4 further including at least one magnetic pickup, positioned sufficiently close to the piston to sense the position of the piston along the longitudinal axis, the at least one magnetic pickup communicating with the driver so as to influence the strength and the direction of the generated magnetic field according to the sensed position of the piston.

9. The linear translation apparatus of claim 2 wherein the piston and tube are keyed by forming the piston and inner wall of the tube to have corresponding cross-sections that are not radially symmetric.

10. The linear translation apparatus of claim 6 wherein the inner wall of the tube includes a guide parallel to the longitudinal axis and the piston includes a channel configured to receive the guide.

11. The linear translation apparatus of claim 6 wherein the piston includes a ridge and the inner wall includes a channel parallel to the longitudinal axis configured to receive the ridge.

12. The linear translation apparatus of claim 6wherein the inner wall of the tube includes a flat segment extending parallel to the longitudinal axis and the piston includes a flat portion aligned with the flat segment of the inner wall.

13. A linear translation apparatus for an optical system, comprising:
a tube having a cylindrical inner wall disposed about a longitudinal axis, the tube optically transmissive at at least one of a first end and a second end;
a piston slidably coupled to the cylindrical inner wall of the tube, moveable along the longitudinal axis and having a magnetic moment aligned with the longitudinal axis;
at least one optical element mounted on the piston adapted to intercept optical signals from the at least one optically transmissive end;
a magnetic actuator generating a magnetic field aligned with the longitudinal axis, positioned sufficiently close to the piston to vary the position of the piston along the longitudinal axis according to a strength and a direction of the generated magnetic field; and
a driver coupled to the magnetic actuator, establishing a time-varying profile for the strength and the direction of the generated magnetic field.

14. The linear translation apparatus of claim 13 wherein the tube is glass.

15. The linear translation apparatus of claim 13 wherein the piston is graphite.

16. The linear translation apparatus of claim 14 wherein the piston is graphite.

17. The linear translation apparatus of claim 13 wherein the cylindrical inner wall of the tube has a guide parallel to the longitudinal axis and the piston has a channel configured to receive the guide.

18. The linear translation apparatus of claim 16 wherein the cylindrical inner wall of the tube has a guide parallel to the longitudinal axis and the piston has a channel configured to receive the guide.

19. The linear translation apparatus of claim 13 wherein the cylindrical inner wall of the tube has a flat segment extending parallel to the longitudinal axis and the piston includes a flat portion aligned with the flat segment of the inner wall.

20. The linear translation apparatus of claim 16 wherein the cylindrical inner wall of the tube has a flat segment extending parallel to the longitudinal axis and the piston includes a flat portion aligned with the flat segment of the inner wall.
